(19) United States
(12) Patent Application Publication
(10) Pub. No.: US 2026/0052566 A1
(43) Pub. Date: Feb. 19, 2026

(54) COMPARISON BASED CHANNEL OCCUPANCY TIME OPERATION

(71) Applicant: Lenovo (Singapore) Pte. Ltd., Singapore (SG)

(72) Inventors: Karthikeyan Ganesan, Nauheim (DE); Alexander Golitschek Edler von Elbwart, Darmstadt (DE); Joachim Löhr, Wiesbaden (DE); Prateek Basu Mallick, Dreieich (DE)

(21) Appl. No.: 19/102,250

(22) PCT Filed: Aug. 8, 2023
(86) PCT No.: PCT/IB2023/058022

§ 371 Date: Feb. 7, 2025

Related U.S. Application Data
(60) Provisional application No. 63/371,006, filed on Aug. 10, 2022.

(51) Int. Cl. H04W 74/0808; H04B 17/318

(52) U.S. Cl. CPC H04W 74/0808; H04B 17/328

(57) ABSTRACT

Apparatuses, methods, and systems are disclosed for comparison based channel occupancy time (“COT”) operation. One method includes determining, prior to initiating a COT, whether there is at least one resource reservation within a COT duration. The method includes in response to determining that there is at least one resource reservation within the COT duration, comparing a first priority, a first at least one reference signal received value (“RSRP”) value, a first overbooking factor, or some combination thereof of the at least one resource reservation with a second priority, a second at least one RSRP value, a packet data block (“PDB”), or some combination thereof of the UE performing a listen-before-talk (“LBT”) to initiate the COT. The method includes determining to initiate the COT, terminate the COT, defer the COT, or share the COT based on an outcome of the comparing.

### FIELD

The subject matter disclosed herein relates generally to wireless communications and more particularly relates to comparison based channel occupancy time (“COT”) operation.

### BACKGROUND

In certain wireless communications systems, a clear channel assessment procedure may be performed. In such systems, transmissions may be made after the clear channel assessment procedure is successfully performed.

### BRIEF SUMMARY

Methods for comparison based COT operation are disclosed. Apparatuses and systems also perform the functions of the methods. One embodiment of a method includes determining, at a user equipment (“UE”), prior to initiating a COT, whether there is at least one resource reservation within a COT duration. In some embodiments, the method includes, in response to determining that there is at least one resource reservation within the COT duration, comparing a first priority, a first at least one reference signal received power (“RSRP”) value, a first overbooking factor, or some combination thereof of the at least one resource reservation with a second priority, a second at least one RSRP value, a physical data block (“PDB”), or some combination thereof of the UE performing a listen-before-talk (“LBT”) to initiate the COT. In certain embodiments, the method includes determining to initiate the COT, terminate the COT, defer the COT, or share the COT based on an outcome of the comparing.

One apparatus for comparison based COT operation includes a processor to: determine, prior to initiating a COT, whether there is at least one resource reservation within a COT duration; in response to determining that there is at least one resource reservation within the COT duration, compare a first priority, a first at least one RSRP value, a first overbooking factor, or some combination thereof of the at least one resource reservation with a second priority, a second at least one RSRP value, a PDB, or some combination thereof of the UE performing a LBT to initiate the COT; and determine to initiate the COT, terminate the COT, defer the COT, or share the COT based on an outcome of the comparing.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for comparison based COT operation;

FIG. 2 is a schematic block diagram illustrating one embodiment of an apparatus that may be used for comparison based COT operation;

FIG. 3 is a schematic block diagram illustrating one embodiment of an apparatus that may be used for comparison based COT operation;

FIGS. 4A through 4D are schematic block diagrams illustrating embodiments of sidelink slot structures;

FIG. 5 is a schematic block diagram illustrating one embodiment of a system for COT deferral;

FIG. 6 is a schematic block diagram illustrating one embodiment of a system for COT sharing in reserved resources; and

FIG. 7 is a flow chart diagram illustrating one embodiment of a method for comparison based COT operation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

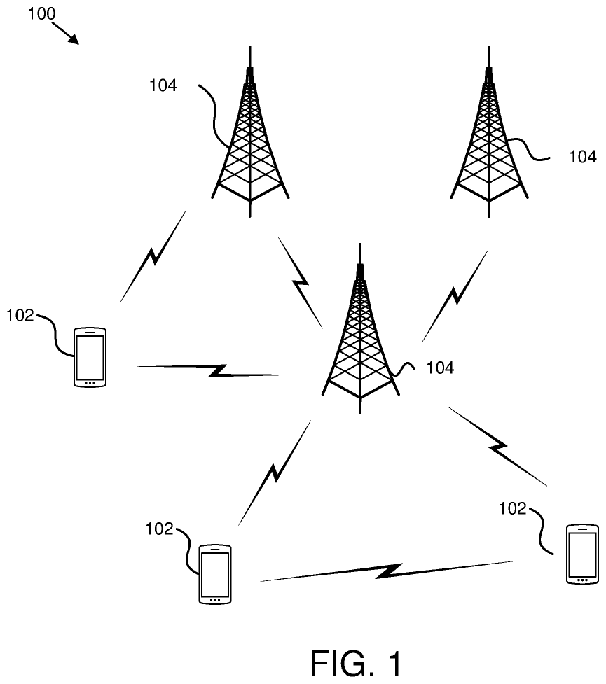

FIG. 1 depicts an embodiment of a wireless communication system 100 for comparison based COT operation. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may determine, prior to initiating a COT, whether there is at least one resource reservation within a COT duration. In some embodiments, the remote unit 102 may, in response to determining that there is at least one resource reservation within the COT duration, compare a first priority, a first at least one RSRP value, a first overbooking factor, or some combination thereof of the at least one resource reservation with a second priority, a second at least one RSRP value, a PDB, or some combination thereof of the UE performing a LBT to initiate the COT. In certain embodiments, the remote unit 102 may determine to initiate the COT, terminate the COT, defer the COT, or share the COT based on an outcome of the comparing. Accordingly, the remote unit 102 may be used for comparison based COT operation.

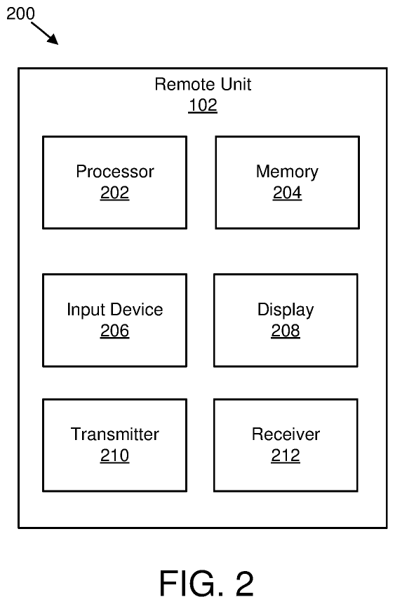

FIG. 2 depicts one embodiment of an apparatus 200 that may be used for comparison based COT operation. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 to: determine, prior to initiating a COT, whether there is at least one resource reservation within a COT duration; in response to determining that there is at least one resource reservation within the COT duration, compare a first priority, a first at least one RSRP value, a first overbooking factor, or some combination thereof of the at least one resource reservation with a second priority, a second at least one RSRP value, a PDB, or some combination thereof of the UE performing a LBT to initiate the COT; and determine to initiate the COT, terminate the COT, defer the COT, or share the COT based on an outcome of the comparing.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

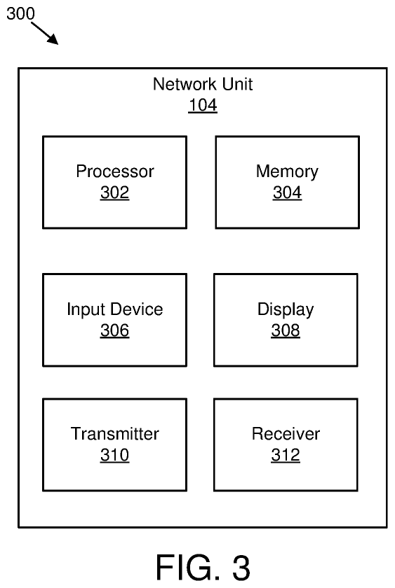

FIG. 3 depicts one embodiment of an apparatus 300 that may be used for comparison based COT operation. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

It should be noted that one or more embodiments described herein may be combined into a single embodiment.

In certain embodiments, sidelink (“SL”) unlicensed operation may be used and a channel access mechanism for SL in an unlicensed band may be used.

In some embodiments, gNB initiated COT sharing and/or UE initiated COT sharing may be used. In various embodiments, a group common downlink control information (“DCI”) format 2_0 may indicate one or more COT sharing indicators initiated by the gNB to each of multiple cells, and a UE initiated COT sharing indicator may be shared to a gNB using a field in configured grant (“CG”) uplink control information (“UCI”) (“CG-UCI”).

In certain embodiments, COT sharing indicator may be used in SL for an unlicensed spectrum to get feedback from receiver (“RX”) UEs, physical sidelink shared channel (“PSSCH”) transmission from RX UEs, and so forth in a remaining channel occupancy duration. In some embodiments, UE-to-UE COT sharing procedures may consider a transmitter (“TX”) UE connection with multiple RX UEs and/or destination identifiers (“IDs”).

In some embodiments, when a sidelink device successfully performs a clear channel assessment procedure on an indicated resource using a mode 1 grant otherwise selected and/or reserved resource using the mode 2 procedure, the sidelink device starts a burst transmission until the end of the channel occupancy duration specified according to a channel access priority class (“CAPC”) value and might block listen-before-talk (“LBT”) from other UEs, which may lead to LBT blocking issues.

In various embodiments, LBT blocking issues may be analyzed if one UE successfully performs clear channel assessment procedure while blocking other UEs reserved resources and thereby there may be solutions to avoid LBT blocking.

TABLE 1
CAPC

| Channel | | | | | |
|---|---|---|---|---|---|
| Access | | | | | |
| Priority | | | | | |
| Class (p) | mₚ | CW_{min, p} | CW_{max, p} | T_{mcot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, |
| | | | | ms | 255, 511, 1023} |

As used herein, the term eNB and/or gNB may be used for a base station (“BS”) but it may be replaceable by any other radio access node (e.g., access point (“AP”), NR, and so forth). Furthermore, certain embodiments described herein are discussed mainly in the context of 5G NR; however, the embodiments herein may be applicable to other mobile communication systems supporting serving cells and/or carriers being configured for sidelink communication over a vehicle to vehicle (“PC5”) interface.

In various embodiments, an inter-UE LBT blocking issue may be solved by: 1) the TX UE, before initiating a COT, checks whether there are any reserved resources (e.g., a reservation) including a priority, reference signal received power (“RSRP”) values, an overbooking factor, or some combination thereof within a maximum COT (“MCOT”) duration and a) decides to initiate the COT when the priority, the RSRP values, the overbooking factor, a packet delay budget (“PDB”), or some combination thereof of the reserved resources is below a certain configured threshold, and b) decides to defer the COT until or after the reserved resources when the priority, the RSRP values, the overbooking factor, the PDB or some combination thereof of the reserved resources are above a certain configured threshold—a resource is re-selected or a resource re-selection is triggered to find a resource according to the deferred duration; 2) the COT initiator checks for any reserved resources within the MCOT as part of sensing and/or resource re-evaluation to determine if there are high priority, RSRP values, overbooked, or some combination thereof reservations then the COT initiator may, a) terminate the COT before one or more reserved resources when the priority, the RSRP values, the overbooking factor, the PDB or some combination thereof of the reserved resources are above certain configured threshold to allow another UE's high priority transmission by not performing transmission in the reserved resources allowing the other UE to successfully complete the LBT procedure, and b) performs COT sharing of one or more reserved resources when the priority, the RSRP values, the overbooking factor, the PDB, or some combination thereof of the reserved resources is above a certain configured threshold to allow another UE's high priority transmission; and 3) the TX UE's candidate resource selection procedure may be enhanced such that a resource exclusion procedure may check for any high priority reservations within the MCOT duration and may exclude candidate contiguous resources until the MCOT that may overlap with that of one or more reserved resources when the priority, the RSRP values, the overbooking factor, the PDB, or some combination thereof of the reserved resources are above a certain configured threshold.

As used herein, the following definitions may be used for sidelink channel access mechanisms: 1) TX UE: a UE that transmits COT sharing information (e.g., a COT sharing indicator) via a sidelink connection; 2) RX UE: a UE that receives COT sharing information (e.g., a COT sharing indicator) via a sidelink connection; 3) COT initiator: a sidelink device that initiated a channel occupancy (e.g., TX UE); 4) COT donor: a sidelink device that transmits COT sharing information (e.g., a COT sharing indicator, a TX UE)—the COT donor may be identical to the COT initiator; and 5) COT recipient: a sidelink device that receives COT sharing information (e.g., a COT sharing indicator, a RX UE).

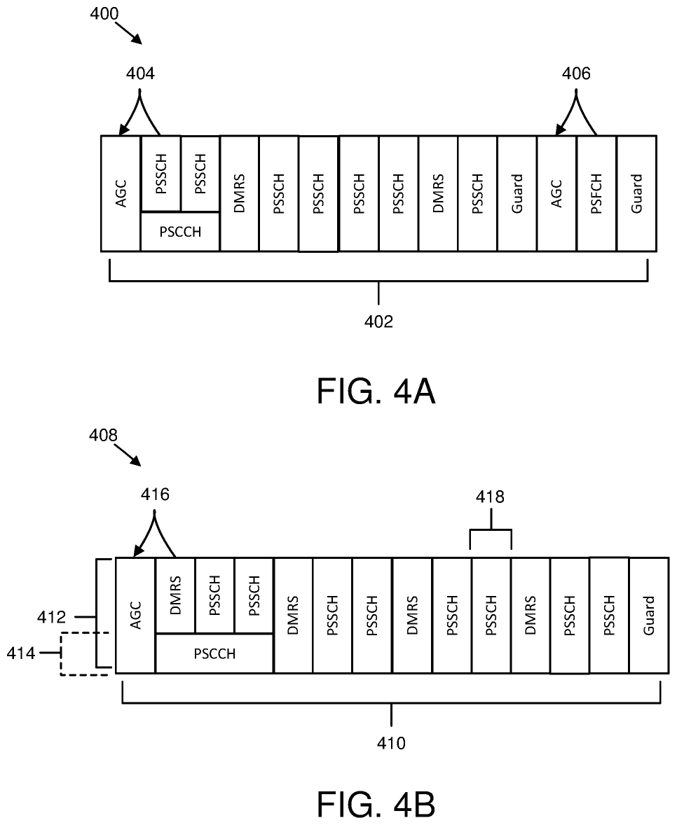

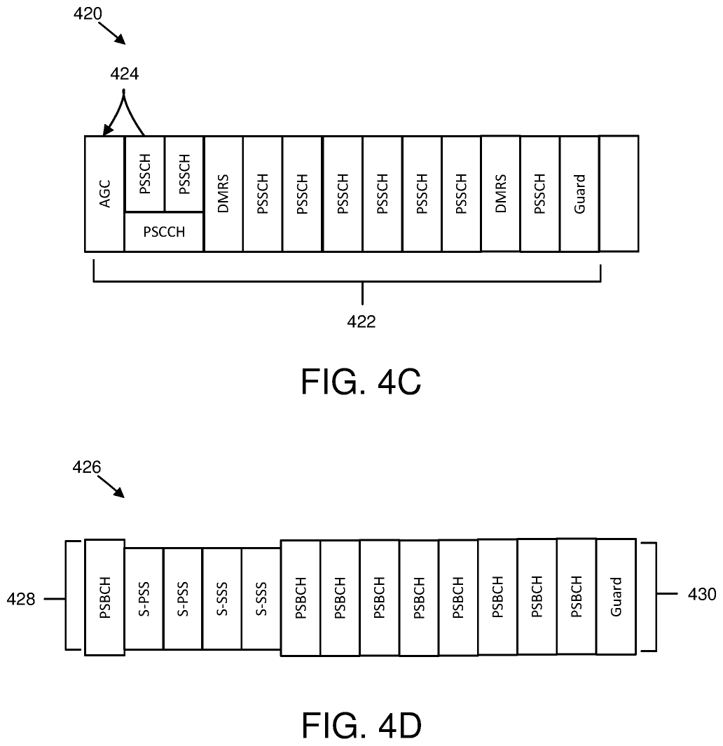

In some embodiments, a SL slot structure contains automatic gain control (“AGC”) symbols at the beginning of the SL slot, then a physical sidelink control channel (“PSCCH”) symbol followed by PSSCH symbols, and the last symbol in the SL slot is configured as a gap symbol (e.g., guard as shown in FIGS. 4A through 4D) to enable a switching time from TX to RX.

In various embodiments, a resource pool maybe configured and/or preconfigured with one or two physical sidelink feedback channel (“PSFCH”) symbols, using a PSFCH period of 1, 2, 4, or 8 slots and the slots where the PSFCH occurs may be configured with an additional AGC symbol and a gap symbols as seen from FIGS. 4A through 4D to enable switching from TX to RX for the reception of hybrid automatic repeat request (“HARQ”) feedback.

FIGS. 4A through 4D are schematic block diagrams illustrating embodiments of sidelink slot structures. Specifically, FIG. 4A 400 illustrates a slot 402 with 14 sidelink symbols available, a first duplicated symbol 404, and a second duplicated symbol 406. Further, FIG. 4B 408 illustrates a slot 410 with 14 sidelink slots available, M_{PSSCH} physical resource blocks (“PRBs”) 412 over L_{PSSCH} subchannels, M_{PSCCH} PRBs 414, a duplicated symbol 416, and a symbol 418. Moreover, FIG. 4C 420 illustrates a slot 422 with 13 sidelink slots available and a duplicated symbol 424. FIG. 4D 426 illustrates a slot with 14 sidelink slots available, 127 subcarriers 428, and M_{S-SSB} 430=11 RBs.

In certain embodiments, contiguous transmission may be needed to be performed in a sidelink unlicensed spectrum after initiating a channel occupancy by a COT initiator UE and the gap duration (e.g., guard in FIGS. 4A through 4D) needed to perform category (“Cat”) 2 LBT to access a shared COT by the COT recipient UE may be less than or equal to 16 and/or 25 microseconds. Thus, in such embodiments, to enable the contiguous transmission in SL, a slot structure may need to be defined without gap symbols and with cyclic prefix extension (“CP-Ext”) symbols to reduce the gap duration.

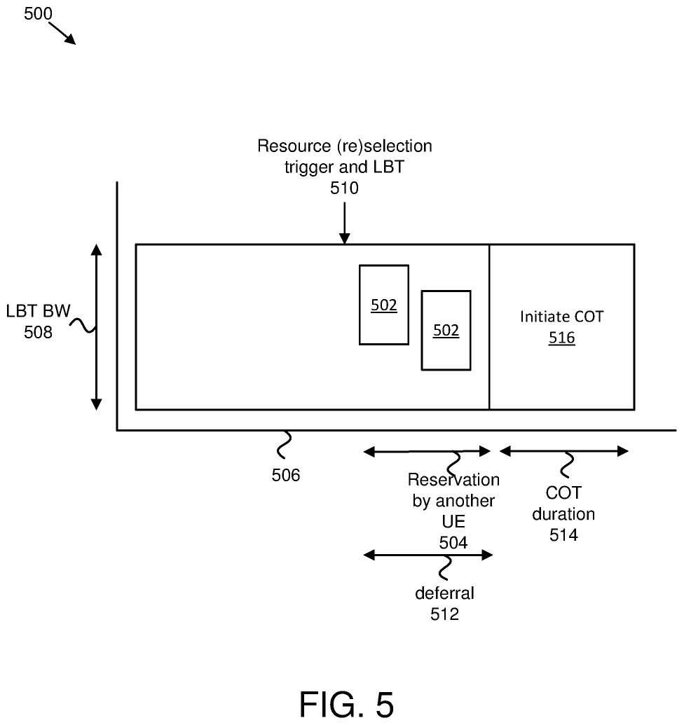

In a first embodiment, one solution to an inter-UE LBT blocking issue is described. According to the first embodiment, the inter-UE LBT blocking issue may be addressed when:
1) the TX UE, before successfully initiating LBT using a CAPC value on an indicated resource and/or selected resource, performs a new evaluation mechanism at a first time (e.g., T1) in a time domain interval starting from the indicated resource and/or selected resource until T1−X slots, where X is the number of the time domain slots. The new evaluation mechanism checks in past time domain X slots whether there are any future reservations that may fall within the intended COT duration (e.g., Y slots) and in addition to that compares a priority, RSRP values, overbooked resources, or some combination thereof of the TX UE intended LBT using a CAPC value (or logical channel (“LCH”) priority) on the selected resource with that of the sidelink control information (“SCI”) signaling the reserved resources within the time domain interval. The TX UE may further decide, according to the outcome of the new evaluation mechanism, whether to initiate the COT, abort and/or terminate the acquired COT, or defer the COT. An overbooking factor means a number of UEs allowed to reserve the same time-frequency resource;
In a first option (e.g., Option 1): the TX UE may successfully initiate the COT when the priority, the RSRP values, the overbooking factor, the PDB, or some combination thereof of the reservation is below a certain configured priority threshold. In another implementation, the TX UE may successfully initiate the COT when the priority, the RSRP values, the overbooking factor, the PDB, or some combination thereof of the reservation (e.g., reserved resources) is a low priority (e.g., low priority may mean a higher PDSCH rate matching and quasi-co-location indicator (“PQI”) and/or LCH priority value) compared to the TX UE's transport block priority that may be used to initiate the COT;
In a second option (e.g., Option 2): the TX UE may decide the defer the COT until or after the reserved resources when the priority, the RSRP values, the overbooking factor, the PDB, or some combination thereof of the reservation is below a certain configured threshold. In another implementation, the TX UE may defer the COT when the priority, the RSRP values, the overbooking factor, the PDB, or some combination thereof of the reservation (e.g., reserved resources) is a low priority (e.g., low priority may mean a higher PQI and/or LCH priority value) compared to the TX UE's transport block priority that may be used to initiate the COT;
FIG. 5 is a schematic block diagram illustrating one embodiment of a system 500 for COT deferral. In the system 500, reserved resources 502 are shown over a time period 504 of a reservation by another UE over a time axis 506 and LBT bandwidth (“BW”) 508. At a time 510, a resource selection (e.g., or reselection) trigger and LBT is indicated. Based on deciding to defer a COT, there is a deferral time 512 until a COT duration 514 so that a step to initiate COT 516 is deferred. The deferred value may be selected from a set of values configured in a resource pool or a UE may choose a deferred duration value in term of a number of slots or milliseconds after the reserved resources 502. A resource is re-selected or a resource re-selection is triggered to find a resource that occurs after the deferred duration.

In a third option (e.g., Option 3): the TX UE may not initiate the COT (e.g., does not perform any SL transmission in the COT duration) when the priority, the RSRP values, the overbooking factor, the PDB, or some combination thereof of the reservation is above a certain configured threshold. In another implementation, the TX UE may not initiate the COT when the priority, the RSRP values, the overbooking factor, the PDB, or some combination thereof of the reservation (e.g., reserved resources) is a high priority (e.g., high priority may mean a lower PQI and/or LCH priority value) compared to the TX UE's transport block priority that may be used to initiate the COT;

In a fourth option (e.g., Option 4): the TX UE may perform COT sharing with UEs whose one or more reserved resources are within the TX UEs COT duration when the priority, the RSRP values, the overbooking factor, the PDB or some combination thereof of the reservation is above a certain configured threshold to allow another UE's high priority transmission;

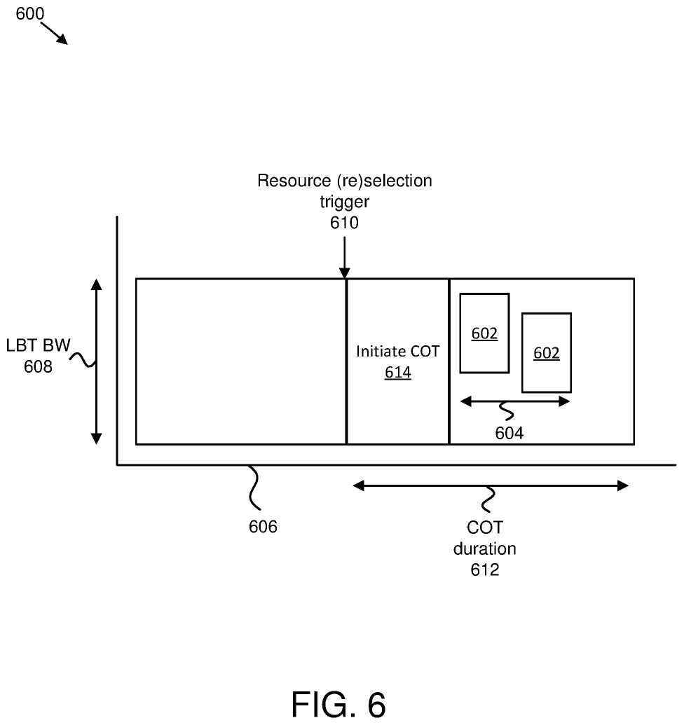

FIG. 6 is a schematic block diagram illustrating one embodiment of a system 600 for COT sharing in reserved resources. In the system 600, reserved resources 602 are shown over a time period 604 of a reservation by another UE over a time axis 606 and LBT BW 608. At a time 610, a resource selection (e.g., or reselection) trigger is indicated. Based on deciding to share a COT, there is a COT duration 612 includes a step to initiate COT 614 without delay and the reserved resources 602 are within the shared COT duration 612.

In a fifth option (e.g., Option 5): the TX UE may successfully initiate the COT and perform SL transmission on the initiated COT and may stop and/or defer the SL transmission on one or more reserved resources based on the priority, the RSRP values, the overbooking factor, the PDB, or some combination thereof of the reservation being below a certain configured threshold. In another implementation, the TX UE may successfully initiate the COT when the priority, the RSRP values, the overbooking factor, the PDB, or some combination thereof of the reservation (e.g., reserved resources) is a low priority (e.g., low priority may mean a higher PQI and/or LCH priority value) compared to the TX UE's transport block priority that may be used to initiate the COT. In the fifth option, the TX UE may perform a Cat 2 LBT to transmit after allowing other UEs transmission in one or more reserved resources within the originally initiated remaining COT duration, otherwise the TX UE may initiate a new COT.

In a sixth option (e.g., Option 6): there may be combination of one or more of the first through fifth options.

In certain embodiments, a UE may transmit mode 1 signaling informing a gNB about a UE decision of whether the UE decides to initiate a COT, abort and/or terminate the acquired COT, or defer the COT. According to one implementation, a separate physical uplink control channel (“PUCCH”) resource may be provided to signal to the BS a selected option. According to another implementation, the UE may transmit a non-acknowledgment (“NACK”) to ask for more retransmission resources to perform LBT.

In a second embodiment, a TX UE's candidate resource selection procedure may be enhanced such that the resource exclusion procedure may check for any high priority reservations, may exclude candidate contiguous resources containing one or more reserved resources, and may find candidate contiguous resources after the one or more reserved resources if PDB is met when a priority, RSRP values, overbooking factor, a PDB, or some combination thereof of the reservation is above a certain configured threshold. The candidate resource selection algorithm may need MCOT to select contiguous candidate resources to perform LBT where the first resource starting position and the duration may be reported in a set S_{A}.

In a third embodiment, a TX UE may indicate a remaining channel occupancy duration received from a COT sharing indicator in a candidate resource selection algorithm to immediately select and report candidate resources within the COT and may also report candidate resource outside the COT which may be provided in separate set S_{A} resources. Since there is a processing time involved in the candidate resource selection procedure, the COT sharing indicator may be received X slots before considering the minimum processing time requirement.

In a fourth embodiment, when a COT sharing indicator is received X slots early where a minimum gap is provided according to a scheduling request (“SR”) configuration and SR processing turnaround time for a SL grant, the UE may transmit SR immediately after receiving the COT sharing indicator. The SR, a buffer status report (“BSR”), or medium access control (“MAC”) control element (“CE”) may include a remaining channel occupancy duration to get a SL grant.

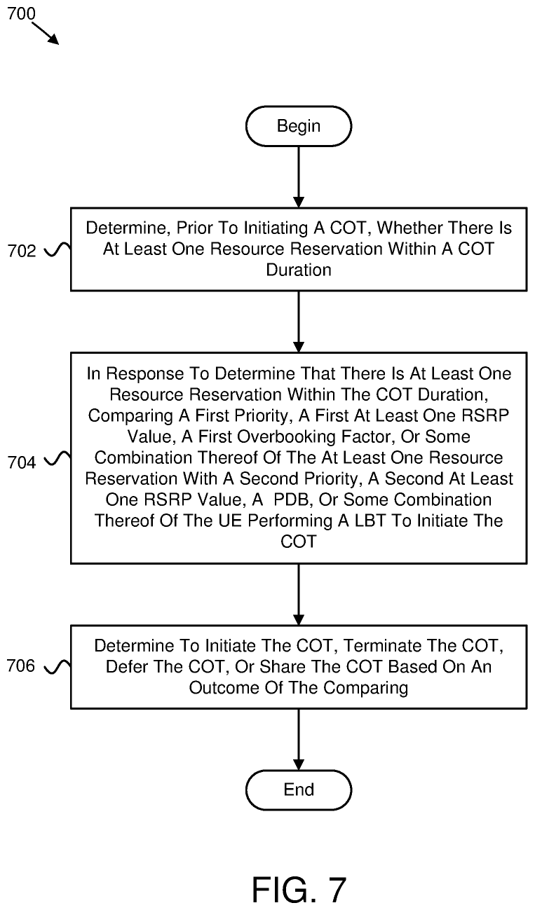

FIG. 7 is a flow chart diagram illustrating one embodiment of a method 700 for comparison based COT operation. In some embodiments, the method 700 is performed by an apparatus, such as the remote unit 102. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes determining 702, prior to initiating a COT, whether there is at least one resource reservation within a COT duration. In some embodiments, the method 700 includes in response to determining that there is at least one resource reservation within the COT duration, comparing 704 a first priority, a first at least one RSRP value, a first overbooking factor, or some combination thereof of the at least one resource reservation with a second priority, a second at least one RSRP value, a PDB, or some combination thereof of the UE performing a LBT to initiate the COT. In certain embodiments, the method 700 includes determining 706 to initiate the COT, terminate the COT, defer the COT, or share the COT based on an outcome of the comparing.

In certain embodiments, the method 700 further comprises determining to initiate the COT in response to the first priority, the first at least one RSRP value, the first overbooking factor, or some combination thereof of the at least one resource reservation being below a corresponding threshold. In some embodiments, the method 700 further comprises determining to terminate the COT in response to the first priority, the first at least one RSRP value, the first overbooking factor, or some combination thereof of the at least one resource reservation being above a corresponding threshold. In various embodiments, the method 700 further comprises determining to defer the COT in response to the first priority, the first at least one RSRP value, the first overbooking factor, or some combination thereof of the at least one resource reservation being above a corresponding threshold.

In one embodiment, determining to defer the COT comprises deferring the COT until after the at least one resource reservation. In certain embodiments, the method 700 further comprises determining to share the COT in response to the first priority, the first at least one RSRP value, the first overbooking factor, or some combination thereof of the at least one resource reservation being above a corresponding threshold. In some embodiments, the method 700 further comprises transmitting information indicating whether the UE is to initiate the COT, terminate the COT, defer the COT, or share the COT.

In various embodiments, the information comprises mode 1 signaling. In one embodiment, the information is transmitted in a PUCCH resource. In certain embodiments, the information is transmitted to a network device.

In one embodiment, an apparatus comprises: a processor to: determine, prior to initiating a COT, whether there is at least one resource reservation within a COT duration; in response to determining that there is at least one resource reservation within the COT duration, compare a first priority, a first at least one RSRP value, a first overbooking factor, or some combination thereof of the at least one resource reservation with a second priority, a second at least one RSRP value, a PDB, or some combination thereof of the UE performing a LBT to initiate the COT; and determine to initiate the COT, terminate the COT, defer the COT, or share the COT based on an outcome of the comparing.

In certain embodiments, the processor further to determine to initiate the COT in response to the first priority, the first at least one RSRP value, the first overbooking factor, or some combination thereof of the at least one resource reservation being below a corresponding threshold.

In some embodiments, the processor further to determine to terminate the COT in response to the first priority, the first at least one RSRP value, the first overbooking factor, or some combination thereof of the at least one resource reservation being above a corresponding threshold.

In various embodiments, the processor further to determine to defer the COT in response to the first priority, the first at least one RSRP value, the first overbooking factor, or some combination thereof of the at least one resource reservation being above a corresponding threshold.

In one embodiment, determining to defer the COT comprises deferring the COT until after the at least one resource reservation.

In certain embodiments, the processor further to determine to share the COT in response to the first priority, the first at least one RSRP value, the first overbooking factor, or some combination thereof of the at least one resource reservation being above a corresponding threshold.

In some embodiments, the apparatus further comprises a transmitter to transmit information indicating whether the UE is to initiate the COT, terminate the COT, defer the COT, or share the COT.

In various embodiments, the information comprises mode 1 signaling.

In one embodiment, the information is transmitted in a PUCCH resource.

In certain embodiments, the information is transmitted to a network device.

In one embodiment, a method at a UE, the method comprises: determining, prior to initiating a COT, whether there is at least one resource reservation within a COT duration; in response to determining that there is at least one resource reservation within the COT duration, comparing a first priority, a first at least one RSRP value, a first overbooking factor, or some combination thereof of the at least one resource reservation with a second priority, a second at least one RSRP value, a PDB, or some combination thereof of the UE performing a LBT to initiate the COT; and determining to initiate the COT, terminate the COT, defer the COT, or share the COT based on an outcome of the comparing.

In certain embodiments, the method further comprises determining to initiate the COT in response to the first priority, the first at least one RSRP value, the first overbooking factor, or some combination thereof of the at least one resource reservation being below a corresponding threshold.

In some embodiments, the method further comprises determining to terminate the COT in response to the first priority, the first at least one RSRP value, the first overbooking factor, or some combination thereof of the at least one resource reservation being above a corresponding threshold.

In various embodiments, the method further comprises determining to defer the COT in response to the first priority, the first at least one RSRP value, the first overbooking factor, or some combination thereof of the at least one resource reservation being above a corresponding threshold.

In one embodiment, determining to defer the COT comprises deferring the COT until after the at least one resource reservation.

In certain embodiments, the method further comprises determining to share the COT in response to the first priority, the first at least one RSRP value, the first overbooking factor, or some combination thereof of the at least one resource reservation being above a corresponding threshold.

In some embodiments, the method further comprises transmitting information indicating whether the UE is to initiate the COT, terminate the COT, defer the COT, or share the COT.

In various embodiments, the information comprises mode 1 signaling.

In one embodiment, the information is transmitted in a PUCCH resource.

In certain embodiments, the information is transmitted to a network device.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
determine, prior to initiating a channel occupancy time (COT), whether there is at least one resource reservation within a COT duration;
perform a listen-before-talk (LBT) and select a resource based on the LBT;
in response to determining that there is at least one resource reservation within the COT duration, avoid selection of a set of contiguous candidate resources in response to a reserved resource of a second UE overlapping with the selected resource; and
determine to initiate the COT, terminate the COT, defer the COT, or share the COT based on avoiding selection of the set of contiguous candidate resources.

2. The UE of claim 1, wherein the at least one processor is configured to cause the UE to determine to initiate the COT in response to one or more of a first priority, a first at least one reference signal received power (RSRP) value, or a first overbooking factor of at least one resource reservation being below a corresponding threshold.

3. The UE of claim 1, wherein the at least one processor is configured to cause the UE to determine to terminate the COT in response to one or more of a first priority, a first at least one reference signal received power (RSRP) value, or a first overbooking factor of at least one resource reservation being above a corresponding threshold.

4. The UE of claim 1, wherein the at least one processor is further configured to cause the UE to determine to defer the COT in response to one or more of a first priority, a first at least one reference signal received power (RSRP) value, or a first overbooking factor of at least one resource reservation being above a corresponding threshold.

5. The UE of claim 4, wherein determining to defer the COT comprises deferring the COT until after the at least one resource reservation.

6. The UE of claim 1, wherein the at least one processor is configured to cause the UE to determine to share the COT in response to one or more of a first priority, a first at least one reference signal received power (RSRP) value, or a first overbooking factor of at least one resource reservation being above a corresponding threshold.

7. The UE of claim 1, wherein the at least one processor is configured to cause the UE to transmit information indicating whether the UE is to initiate the COT, terminate the COT, defer the COT, or share the COT.

8. The UE of claim 7, wherein the information comprises mode 1 signaling.

9. The UE of claim 7, wherein the information is transmitted in a physical uplink control channel (PUCCH) resource.

10. The UE of claim 7, wherein the information is transmitted to a network device.

11. A method performed by a user equipment (UE), the method comprising:
determining, prior to initiating a channel occupancy time (COT), whether there is at least one resource reservation within a COT duration;
performing a listen-before-talk (LBT) and selecting a resource based on the LBT;
in response to determining that there is at least one resource reservation within the COT duration, avoiding selection of a set of contiguous candidate resources in response to a reserved resource of a second UE overlapping with the selected resource; and
determining to initiate the COT, terminate the COT, defer the COT, or share the COT based on avoiding selection of the set of contiguous candidate resources.

12. The method of claim 11, further comprising determining to initiate the COT in response to one or more of a first priority, a first at least one reference signal received power (RSRP) value, or a first overbooking factor of at least one resource reservation being below a corresponding threshold.

13. The method of claim 11, further comprising determining to terminate the COT in response to one or more of a first priority, a first at least one reference signal received power (RSRP) value, or a first overbooking factor of at least one resource reservation being above a corresponding threshold.

14. The method of claim 11, further comprising determining to defer the COT in response to one or more of a first priority, a first at least one reference signal received power (RSRP) value, or a first overbooking factor of at least one resource reservation being above a corresponding threshold.

15. The method of claim 14, wherein determining to defer the COT comprises deferring the COT until after the at least one resource reservation.

16. The method of claim 11, further comprising determining to share the COT in response to one or more of a first priority, a first at least one reference signal received power (RSRP) value, or a first overbooking factor of at least one resource reservation being above a corresponding threshold.

17. The method of claim 11, further comprising transmitting information indicating whether the UE is to initiate the COT, terminate the COT, defer the COT, or share the COT.

18. The method of claim 17, wherein the information comprises mode 1 signaling.

19. The method of claim 17, wherein the information is transmitted in a physical uplink control channel (PUCCH) resource.

20. A processor for wireless communication, comprising:
at least one controller coupled with at least one memory and configured to cause the processor to:
determine, prior to initiating a channel occupancy time (COT), whether there is at least one resource reservation within a COT duration;
perform a listen-before-talk (LBT) and select a resource based on the LBT;
in response to determining that there is at least one resource reservation within the COT duration, avoid selection of a set of contiguous candidate resources in response to a reserved resource of a second UE overlapping with the selected resource; and
determine to initiate the COT, terminate the COT, defer the COT, or share the COT based on avoiding selection of the set of contiguous candidate resources.
